(19) United States
(12) Patent Application Publication
(10) Pub. No.: US 2014/0157299 A1
(43) Pub. Date: Jun. 5, 2014

(54) Systems and Methods for Video-Level Reporting

(71) Applicant: Set Media, Inc., San Francisco, CA (US)

(72) Inventors: Julian ALCALA, Berkeley, CA (US); Jonathan Robert DODSON, San Francisco, CA (US); Robert Philip IMPOLLONIA, San Mateo, CA (US); Craig GLENNIE, San Francisco, CA (US); Ben REITER, San Francisco, CA (US); Hardik Jayant SHAH, San Francisco, CA (US); Matthew TILLMAN, San Francisco, CA (US); Clifford WARREN, San Francisco, CA (US)

(73) Assignee: SET MEDIA, INC., San Francisco, CA (US)

(21) Appl. No.: 14/092,055

(22) Filed: Nov. 27, 2013

Related U.S. Application Data
(60) Provisional application No. 61/731,681, filed on Nov. 30, 2012.

(51) Int. Cl. H04N 21/442; H04N 21/2668

(52) U.S. Cl. CPC H04N 21/44222; H04N 21/2668
USPC 725/14

(57) ABSTRACT

Systems and methods are provided for reporting advertisement performance at the video level. The video-level reporting system can include an ad server receiving requests from a user to view a video. The ad server transfers the request to an application programming interface for processing the request. The video-level reporting system can also include a storage and reporting module that stores the requested video and a corresponding advertisement, a video capture module for analyzing the user requested video, an analytics module for identifying user events and analyzing the advertisement performance based on the events, and an indexing module for indexing the requested videos.

### CROSS-REFERENCE TO RELATED APPLICATIONS

This application claims priority under 35 U.S.C. §119(e) to U.S. Provisional Application Ser. No. 61/731,681, entitled “Systems and Methods for Video Level Reporting,” filed on Nov. 30, 2012, which is incorporated herein by reference in its entirety.

### FIELD OF THE INVENTION

The present invention relates to systems and methods for attributing performance data to unique videos for forecasting, targeting, and reporting.

### BACKGROUND

Processing online video is an expensive and time-consuming process. Publishers, for example, websites that have videos, have a variety of ways in which they add new content to their sites. One common method is licensing content from producers of video properties and placing them on watch pages. Watch pages are webpages of the site created dynamically for each piece of content licensed and hosted or linked-to by the publisher. A second common method is allowing users to upload content directly to the publishers' website.

Advertisement (or ad) networks purchase advertisement placement against videos across publishers. Advertisement networks decide to place ads on particular publishers based on the amount of inventory (impressions) that the publisher has and the estimated audience, for example, males aged 18-35, that visit the particular publisher. Networks have to work with many publishers in order to buy the number of impressions required for their clients. Working with many publishers increases the difficulty required to analyze each ad decision. Instead of deciding to run an ad on an individual video, networks use statistics aggregated at a publisher level to simplify the buying and serving process.

Therefore, there is a need for a system to provide reporting for ad performance at the video level. Such a system can successfully track and record impressions for particular ads and provide advertisers with ways to accurately evaluate an ad campaign performance. Moreover, based on analytics gathered at the video level for past ad campaigns, advertisers can more accurately predict the performance of a new ad campaign.

### SUMMARY

Systems and methods for video-level reporting are provided for determining the performance of an advertisement being served on a user device during an advertisement campaign defined by an advertiser. According to exemplary embodiments a system for video-level reporting includes an application programming interface (API) implemented on a computer configured to receive from an advertisement server a Uniform Resource Location (URL) of a video requested by a user and information provided by the advertiser. The video-level reporting system can also include a storage system for storing advertisement-related information, and an analytics module implemented on the computer configured to receive the stored advertisement-related information from the storage system, identify at least one user activity comprising a user interaction with the advertisement being served on the user device, and analyze a performance of the advertisement based on the identified user activity and the stored advertisement-related information.

There has thus been outlined, rather broadly, the features of the disclosed subject matter in order that the detailed description thereof that follows may be better understood, and in order that the present contribution to the art may be better appreciated. There are, of course, additional features of the disclosed subject matter that will be described hereinafter and which will form the subject matter of the claims appended hereto.

In this respect, before explaining at least one embodiment of the disclosed subject matter in detail, it is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the disclosed subject matter. It is important, therefore, that the claims be regarded as including such equivalent constructions insofar as they do not depart from the spirit and scope of the disclosed subject matter.

These together with the other objects of the disclosed subject matter, along with the various features of novelty which characterize the disclosed subject matter, are pointed out with particularity in the claims annexed to and forming a part of this disclosure. For a better understanding of the disclosed subject matter, its operating advantages and the specific objects attained by its uses, reference should be had to the accompanying drawings and descriptive matter in which there are illustrated preferred embodiments of the disclosed subject matter.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 shows components of an exemplary system, according to aspects of the present disclosure.

FIG. 2 shows components of an exemplary system for content query service, according to aspects of the present disclosure.

FIG. 3 shows components of an exemplary system for content classification, according to aspects of the present disclosure.

FIG. 4 shows components of an exemplary system for automated training, according to aspects of the present disclosure.

FIG. 5 shows components of an exemplary system for video-level reporting, according to aspects of the present disclosure.

FIG. 6 shows a flow chart for video-level reporting, according to aspects of the present disclosure.

FIG. 7 shows a flow chart for content query service, according to aspects of the present disclosure.

FIG. 8 shows a high-level exemplary system, according to aspects of the present disclosure.

FIGS. 9-11 show screenshots of an exemplary system, according to aspects of the present disclosure.

FIG. 12 shows an exemplary environment for implementing the disclosed systems and methods.

### DESCRIPTION

In the following description, numerous specific details are set forth regarding the systems, methods and media of the disclosed subject matter and the environment in which such systems, methods and media may operate, etc., in order to provide a thorough understanding of the disclosed subject matter. It will be apparent to one skilled in the art, however, that the disclosed subject matter may be practiced without such specific details, and that certain features, which are well-known in the art, are not described in detail in order to avoid complication of the disclosed subject matter. In addition, it will be understood that the examples provided below are exemplary, and that it is contemplated that there are other systems, methods and media that are within the scope of the disclosed subject matter.

According to aspects of the present disclosure a video-level reporting system includes an ad server and an application programming interface (API). The ad server receives requests from a user to view a video. The ad server transfers the request to the application programming interface for processing the user request. The video-level reporting system also includes a storage and reporting module that stores the requested video and a corresponding advertisement, and receives queries from the API. The video-level reporting system also includes a video capture module for analyzing the user requested video, an analytics module for identifying user events while the corresponding advertisement is displayed to the user and analyzing the advertisement performance based on the events, and an indexing module for indexing the requested videos.

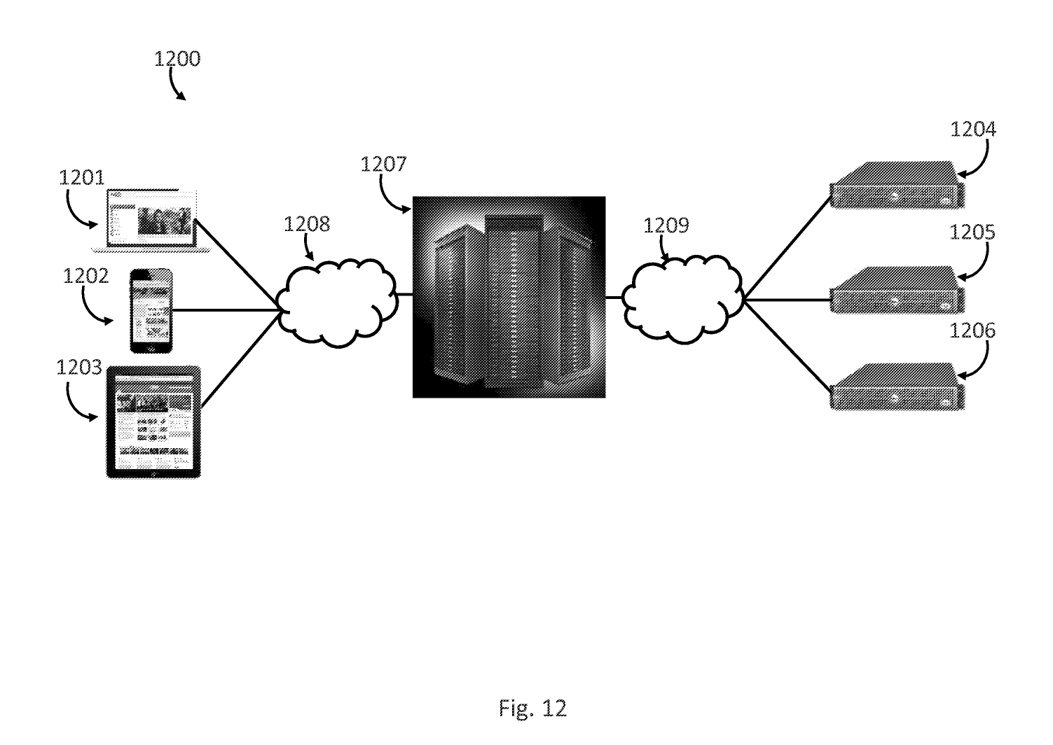

FIG. 12 shows an exemplary environment for practicing the disclosed systems and methods. The systems and methods can be implemented in a network that includes users at computing devices 1201, 1202, and 1203; system 1207; ad servers 1204, 1205, and 1206; and communication mediums 1208 and 1209. Specifically, multiple user computing devices 1201, 1202, and 1203 can request particular webpages that carry video content. Information related to the requests is communicated via communication medium 1208 to system 1207.

System 1207 is also able to communicate with ad servers 1204, 1205, and 1206, which are able to deliver ads to system 1207 via communication medium 1209. System 1207 is able to deliver to users 1201, 1202, and 1203 the received ads from the ad server via communication medium 1208. User computing devices 1201, 1202, and 1203 can include, for example, desktop computers, laptop computers, notebooks, tablets, cellular telephones, such as smartphones and phablet devices, or any other suitable mobile device, video game consoles, a TV with a set top box, an apple TV, a set top box (from cable company), and any TV set or monitor that can show videos, for example, using a Netflix subscription.

System 1207 can communicate with ad servers 1204, 1205, and 1206 and the user computing devices 1201, 1202, and 1203 to determine what ads from what ad server get presented to which user computing device. System 1207 can include software servers that can be run on distributed clusters and can track the data communicated between the ad servers and the user devices and can provide video-level reporting. System 1207 can be a cluster of devices, it can be distributed and can run on any hardware. System 1207 can be at the advertiser side. Communication mediums 1208 and 1209 can include any type of medium, for example, a network, a local area network (LAN), a wide area network (WAN), the Internet, a cellular network, or any suitable combination thereof.

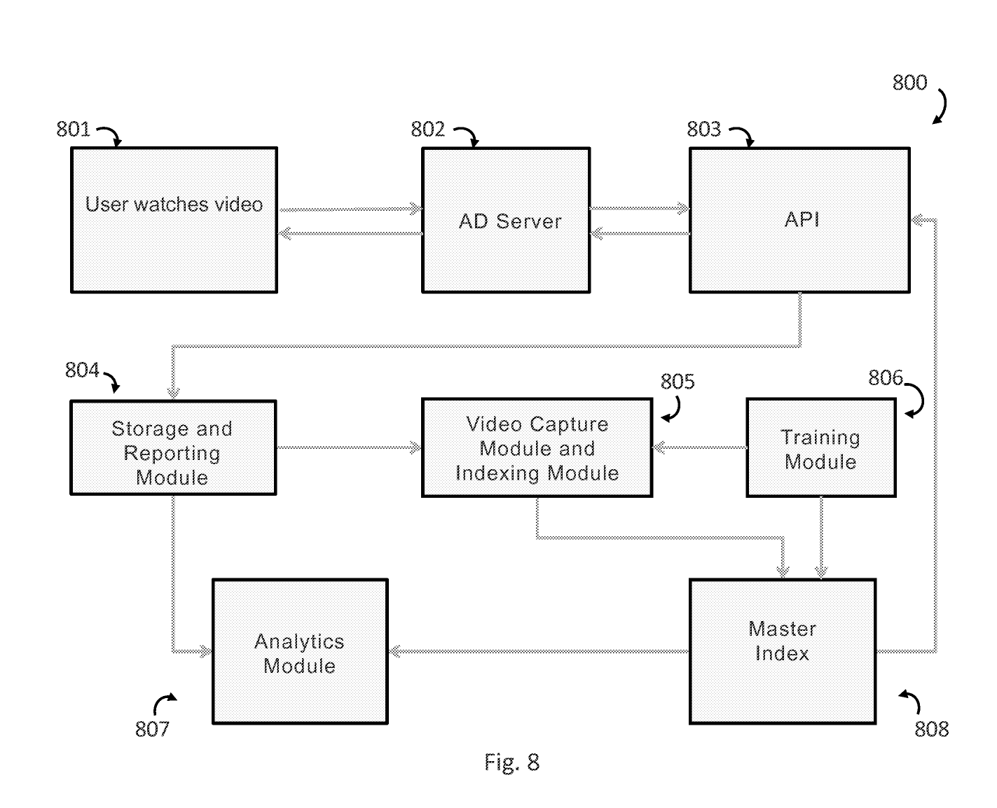

FIG. 8 shows an exemplary diagram 800 of a video-level reporting system according to aspects of the present disclosure. The video-level reporting system 800 includes a user at a computing device 801, an AD Server 802, an Application Programming Interface (API) 803, a Storage and Reporting Module 804, a Video Capture Module and Indexing Module 805, a Training Module 806, an Analytics Module 807, and a Master Index 808. Computing device 801 can be one or more of computing devices 1201-1203; AD Server 802 can be one or more of ad servers 1204-1206; and API 803 and modules 804-808 can be implemented in system 1207. Although API 803 and modules 804-808 are shown as separate components and modules, the functions associated with each of these can be implemented in additional modules, fewer modules, or any suitable combination thereof.

When a user selects an online video for viewing 801, the system sends a notification to the ad server 802. Then, the ad server 802 provides to the API 803 data related to the selected video by the user, as well as a particular advertising target, for example, clothing or electronics. The API 803 can either deliver a matching ad to the video and the advertising target to the user or determine there is no matching ad for the particular video and advertising target. The system can further process the data related to the selected video. Preferably, the system can also detect and log different user events relevant to a particular video, the ad, or the webpage hosting the video. For example, the system can detect user queries, impressions, a click through rate (CTR) or a view completion rate (VCR). All these events can be stored in a Storage and Reporting Module 804.

The system can further include the Video Capture Module and Indexing Module 805 for classifying and indexing videos. The classification includes determining content categories for each video, such that it may be later matched with a particular advertising target. For example, a video can relate to a soccer game, therefore it can be classified into the “soccer” content category. The Video Capture Module and Indexing Module 805 can communicate with the Training Module 806. The Training Module 806 can train new classification detectors, which can in turn be used for classifying the different videos.

The system can further include the Analytics Module 807, which can perform analysis of a particular advertising campaign. For example, the system can track and record the click through rate or view completion rate of a particular ad or group of ads.

Finally, the system can include the Master 808 for storing management data for advertising campaigns and indexes of classified videos.

The following abbreviations are herewith described.

“Gross Rating Point” (or “GRP”) is a term often used in advertising to measure the size of an audience reached by a specific media vehicle or schedule, for example, outdoor billboard advertising, television, video, or newspaper. It is the product of the percentage of the target audience reached by an advertisement, times the frequency the audience sees it in a given campaign (reach (%)×frequency). For example, a television advertisement that is aired 5 times reaching 50% of the target audience each time it is aired, would have a GRP of 250 (50%×5). To achieve a common denominator and compare media, reach x frequency are expressed over time (divided by time) to determine the “weight” of a media campaign. A common denominator is important for comparing ad performance within the same medium but with different circumstances, for example, ads in shows that start at different times in the day. A common denominator is also important for comparing ad performance in a different medium, e.g., an ad shown on the TV against an ad heard over the radio.

“Reach” can refer to the total number of different people or households exposed, at least once, to a particular medium, e.g., TV or radio, during a given period, and therefore have an opportunity to see or hear an ad or commercial. It is a measure of the number of consumers exposed to the medium out of all potential consumers.

The GRP is used predominantly as a measure of media with high potential exposures or impressions, like outdoor advertising in particular, e.g., billboards, or broadcast media. GRP values are commonly used by media buyers to compare the advertising strength of different media vehicles, for example, TV against radio.

“Target Rating Point” (or “TRP”) is a term often used as an audience measurement criterion that gained popularity in television rating points to indicate the popularity of a television channel or program on a particular channel, among a specific target audience. The TRP helps advertisers decide which TV channels and programs to place their advertising on. The TRP can be used beyond television, for example, at any available end point displaying a video, such as a website or a set-top box, to measure the impressions delivered to a specific audience. The TRP is a measure of the purchased points, e.g., the available percentage an advertiser has bought for a particular market and for a particular medium, representing an estimate of the component of the target audience within the gross audience. Similar to the GRP, TRP is measured as the sum of ratings achieved by a specific media vehicle (e.g., TV channel or program) of the target audience reached by an advertisement. For example, if an advertisement appears more than once, also reaching the entire gross audience, the TRP figure is the sum of each individual GRP, multiplied by the estimated target audience in the gross audience. While GPR relates to the whole potential audience, TRP relates to a fraction of the whole potential audience, e.g., the targeted portion. The TRP and GRP metrics are both critical components for determining the marketing effectiveness of a particular advertisement. Outside of television, TRPs are calculated using the numerator as the total impressions delivered to this audience×100 and the denominator as the total target audience. For example, 1,000,000 impressions among the target audience/10,000,000 people in total in the target audience×100=10 TRPs. TRPs are often added up by week, and presented in a flowchart so a marketer can see the amount of impressions delivered to the target audience from each media channel.

As discussed above, networks work with many publishers in order to buy the number of impressions required for their clients. The unit of inventory being purchased by advertisers and, ultimately, networks is a video. The unit of inventory is not a publisher. As discussed above, publishers, for example, can be websites that have videos, and can have a variety of ways in which they add new content to their sites. In TV, for example, when advertisers buy an ad spot on TV, they do not buy Fox Network. Rather advertisers buy “American Idol” because a commercial on “American Idol” is the unit of inventory; the unit is not Fox Network.

According to embodiments of the present invention, the disclosed systems and methods enable the valuation of the unit of inventory, e.g., the video, by analyzing, buying, and measuring performance of an ad campaign at a video level, for example, for each video being streamed and/or watched by a user. The system can identify and record events, for example, user events or activities, relevant to the video, e.g., Interactive Advertising Bureau (IAB) events, such as “start,” “complete,” “pause,” “mute,” “rewind,” “resume,” etc. as well as custom user events or activities that can be defined using the system. The system tracks all the events and activities and correlates them with a particular video providing a detailed user behavior as it relates to the particular video and the particular webpage. A full list of IAB events can be found at the IAB website, for example at, http://www.iab.net/media/fileNASTv3.0.pdf.

According to alternative embodiments of the present invention, the disclosed systems and methods enable reporting of campaign performance at a video level (e.g., post-impression analytics). A campaign performance generally relates to user actions and event data, for example, how many times a particular video was clicked or viewed. Therefore, the GRP and TRP are measures of a campaign performance.

The disclosed systems and methods enable reporting of impressions, clicks, and view-completion rates at a video level. The disclosed systems and methods enable reporting of audience measurements such as GRP and TRP at a video level. The disclosed systems and methods enable reporting audience measurements, such as GRP and TRP at a content category level, for example, how many GRPs are available for soccer or football, e.g., soccer and football correspond to different content categories. The disclosed systems and methods provide advertisers and agencies with the actual videos that they bought a placement against.

According to alternative embodiments of the present invention, the disclosed systems and methods provide forecasting of inventory and campaign performance using video-level details (e.g., forecasting). For example, the disclosed system can process the statistics and analytics associated with each video and predict the performance or success of a particular ad campaign.

According to alternative embodiments of the present invention, the disclosed systems and methods enable audience measurements such as GRPs and TRPs during campaign planning An advertiser can specify the required number of GRPs or TRPs for a campaign and the system can use, for example, the past performance of actual videos to achieve these results. The disclosed systems and methods enable allowing the end-user to view the actual videos and types of videos their campaign will run against.

According to alternative embodiments of the present invention, the disclosed systems and methods enable targeting using advertiser goals matched to the video content itself (e.g., targeting). For example, the disclosed system can provide information to advertisers related to particular and desired consumer target groups.

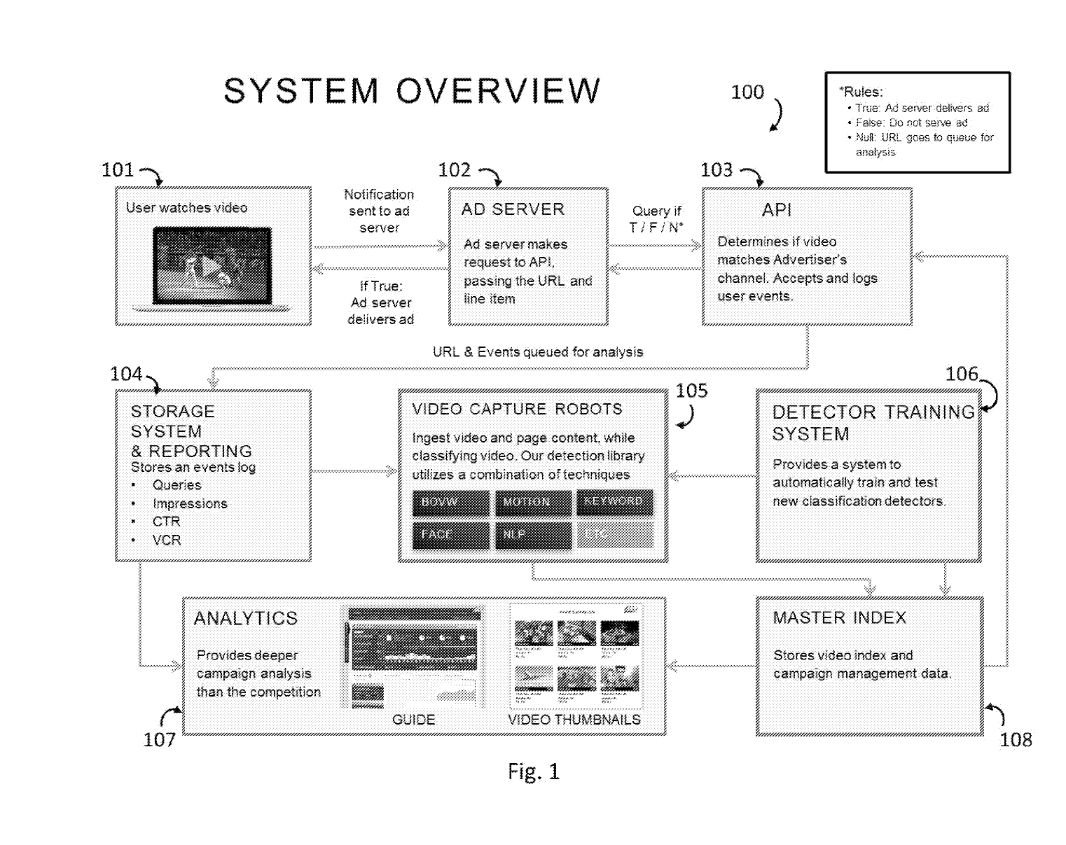

All these embodiments can be realized by the system based in part on the analysis and tracking of user actions or events at the video level. FIGS. 1-5 described below show more detailed diagrams and process flows of the video-level reporting system 800 of FIG. 8.

FIG. 1 shows an exemplary system 100 according to aspects of the present disclosure. When a user selects an online video for viewing 101, the system sends a notification to an ad server 102. Then, the ad server 102 makes a request to an Application Programming Interface (API), for example, the SET API, and passes the Uniform Resource Location (URL) of the video and a line item (or advertising target) to the API. A line item can correspond to any advertising target, for example, cars, health, diet, electronics, sports, etc. An advertiser can set the level of specificity and detail of a particular line item. For example, a line item can be “cars,” or it can be a specific type of car or brand, for example, “Ford” or “Ford Focus.” As another example, a line item can be “cell phones,” or it can be a specific manufacturer (“BlackBerry”) or a specific phone (“iPhone”). One parameter for determining the level of specificity for a particular line item is the available content for that particular item.

The ad server can pass a list of line items to the API. The API can analyze more than one target(s). Targets can be general categories of products, for example, cars and cell phones. A set of targets and filters can define a “channel,” which sets the advertiser preferences. A channel can be linked to a campaign, for example, a campaign to advertise Mercedes Benz or content categories in general. For example, if the ad server passes a list of line items that specify a car brand, such as, “BMW” and “Lexus,” the system can identify a particular target. In this case, the target can be, for example, “cars.” This target can be linked to a particular channel. The channel can also have filters that can be associated to a particular target. For example, a filter can include “luxury cars.” After a channel has been identified, it can be associated with the “Mercedes Benz” campaign. The different targets can be provided by the advertisers or the provider of the system. Channels can be manually or automatically created.

The channel can further be associated with a particular type of media, for example, video or banner. If there is a match, then the ad server delivers the ad to the user. If there is no match, the ad server does not serve the ad. If there is no determination at the API, then the URL is queued for further analysis. The API can also accept and log the different user events.

System 100 further includes a storage system and reporting module 104. Module 104 stores an events log. The events that can be logged can include, for example, queries, impressions, click through rate (“CTR”), and view completion rate (“VCR”) of the advertisement.

System 100 can also include video capture robots 105. These modules can ingest video and page content, e.g., to absorb information and content of the video and the page that is hosting it, while classifying the video. The classification is performed to determine the relevant content categories, such that a line item can be matched. The video capture robots can utilize various techniques, for example, bag of visual words (“BOVW”), motion detection, keyword detection, face detection and recognition, natural processing language (“NLP”), or combination of those. Face detection and recognition techniques are described in U.S. Provisional Application No. 61/836,872, entitled “Automatic Face Discovery and Recognition for Video Content Analysis,” filed on Jun. 19, 2013, the contents of which are incorporated herein in their entirety.

Other modules in the disclosed system include a detector training system 106, an analytics module 107, and a master index module 108. The detector training system 106 can automatically train and test new classification detectors. The analytics module 107 provides detailed campaign analysis. For example, the system can identify the type of requested video and requested URL and can link them to particular events that occur in connection with the video, for example, IAB events discussed above. For example, the analytics module can observe the video completion rate, e.g., when the user watched the entire ad, or the click-through rate, e.g., when the user clicked on a link in connection with the ad, which opened a new webpage about the advertised product. Based on the view completion rate and the click-through rate, the analytics module can provide information about the success of a particular ad campaign. As discussed above, other user activities can be used to analyze the performance of a particular ad campaign.

The master index module 108 stores video indexes and campaign management data. The master index module can store associations of particular labels to particular videos. For example, the master index module can store information about a particular video being associated to the label “sports apparel.” The system can maintain and update the information stored in the master index module on a frequent basis, e.g., hourly. For example, a video that has been associated with “sports apparel” during a first classification could also be associated with “power drinks,” in a subsequent classification. The information about how each video is associated with various labels can be provided to the analytics module. The analytics module can then analyze and compare whether an ad campaign was successful for particular labels. For example, whether an ad campaign for “sports apparel” had a higher completion rate than an ad campaign for “power drinks,” for a particular video.

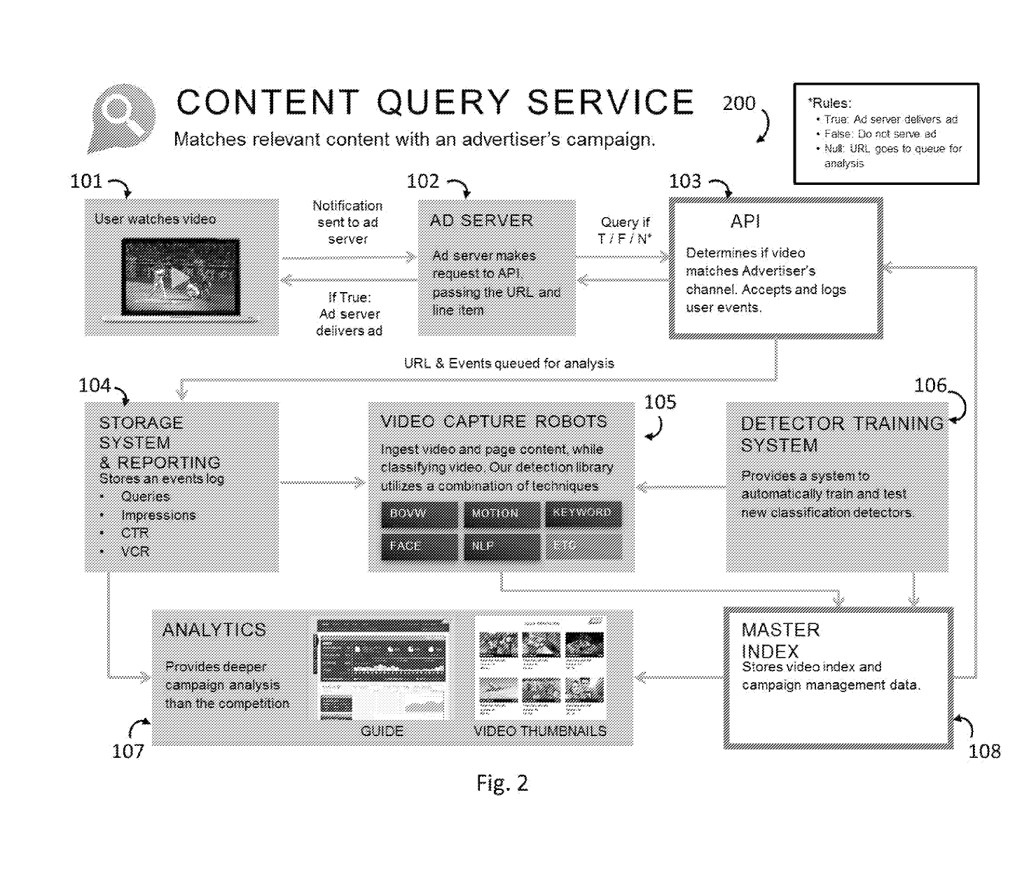

FIG. 2 illustrates an exemplary way for providing content query service according to aspects of the present invention, as shown in FIG. 8. The disclosed API 103 determines whether a video matches an advertiser's channel after receiving video index and campaign management data from the master index module 108. The API 103 can then match relevant content with an advertiser's campaign.

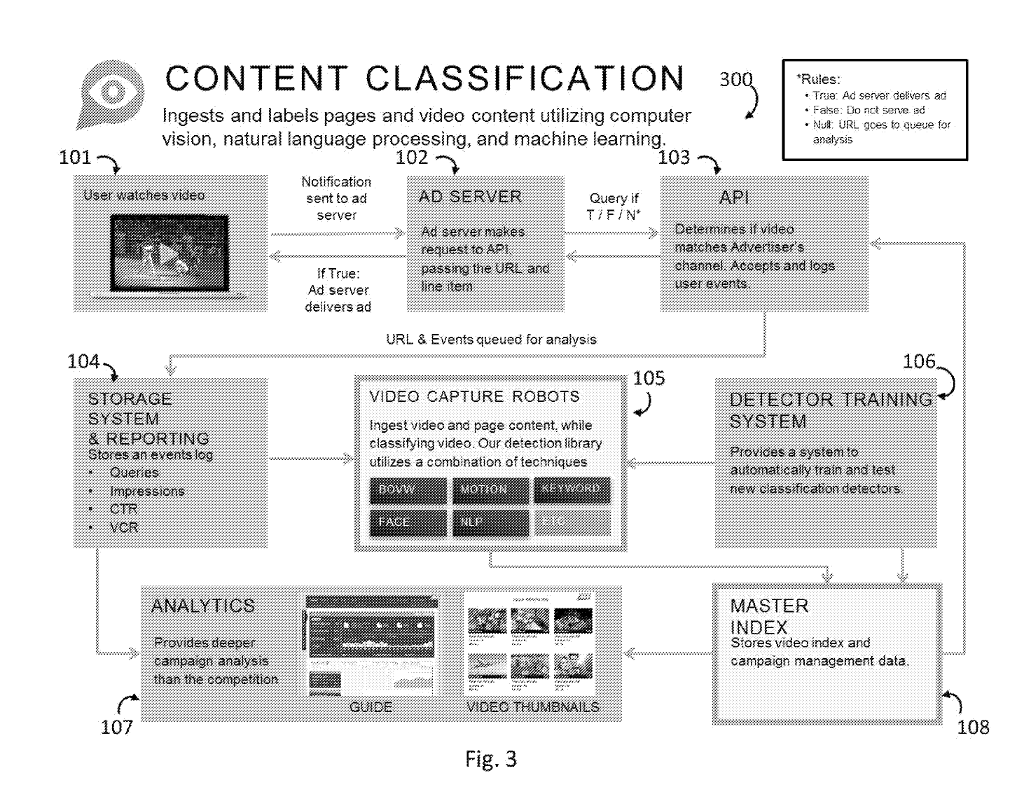

FIG. 3 illustrates an exemplary way for providing content classification according to aspects of the present invention. Video capture robots 105 ingest and label and classify pages and video content utilizing classification techniques, for example, computer vision, natural language processing, and machine learning. The results of the classification are stored in the master index module 108.

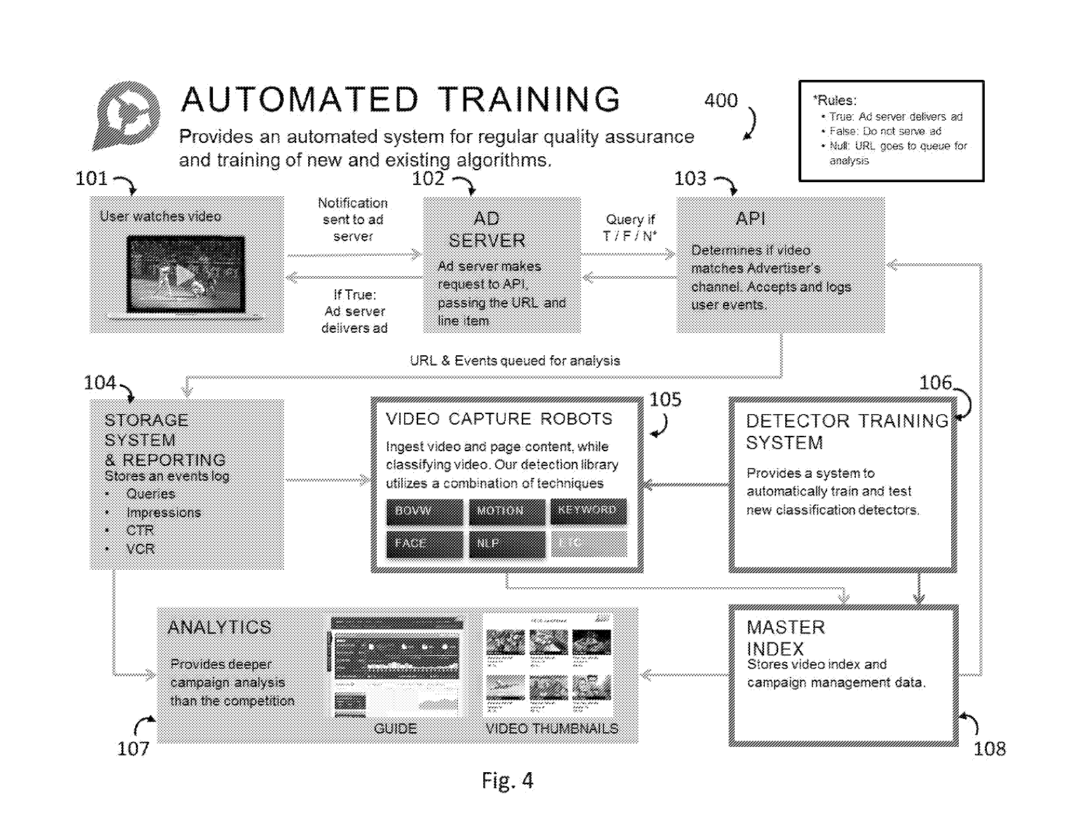

FIG. 4 illustrates an exemplary way for automated training of classification detectors according to aspects of the present invention. For example, the disclosed methods and systems can automatically generate classification models to define advertising channels. Such methods and systems are described in U.S. patent application Ser. No. 13/793,384, filed on Mar. 11, 2013, entitled “Systems and Methods for Defining Video Advertising Channels,” the contents of which are incorporated herein in their entirety by reference.

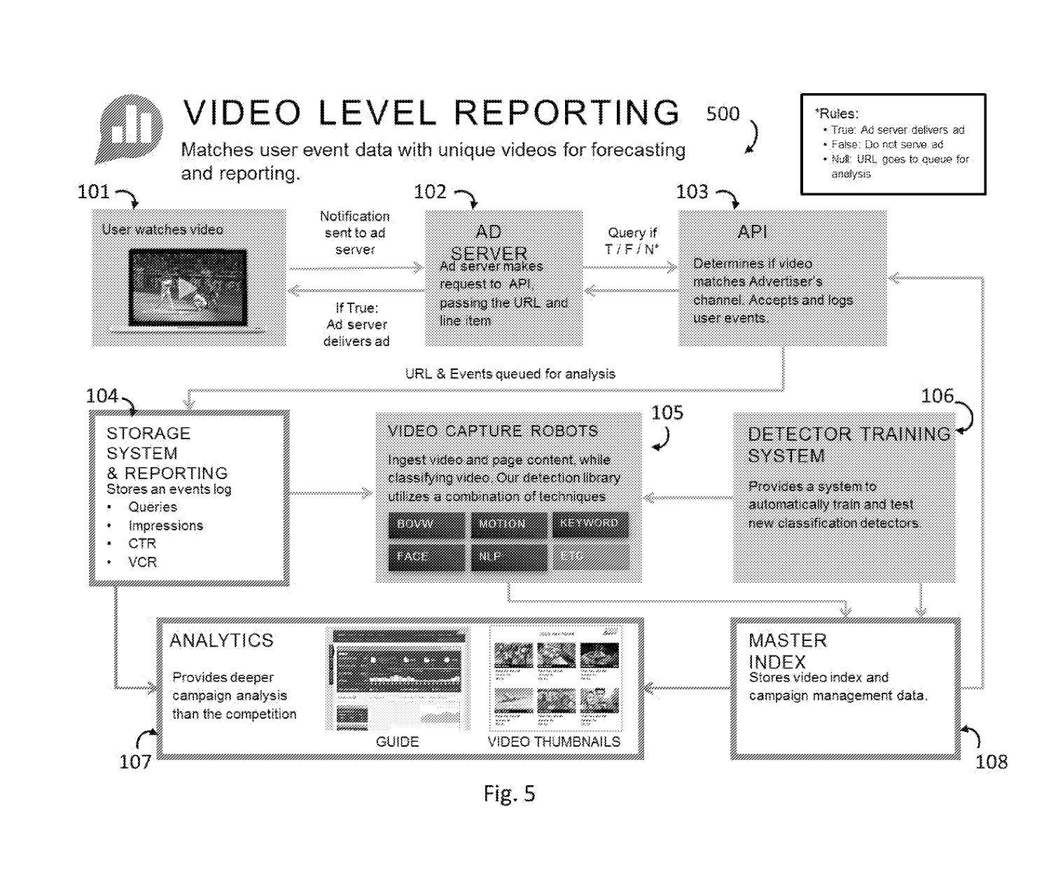

FIG. 5 illustrates an exemplary way for video-level reporting according to aspects of the present invention. The storage system and reporting module 104 receives URLs and events that are queued for analysis by the API module 103. The analytics module 107 receives data and events from the storage system and reporting module 104. The analytics module 107 further receives data from the master index module and analyzes the data and events to provide a detailed campaign analysis at the video level.

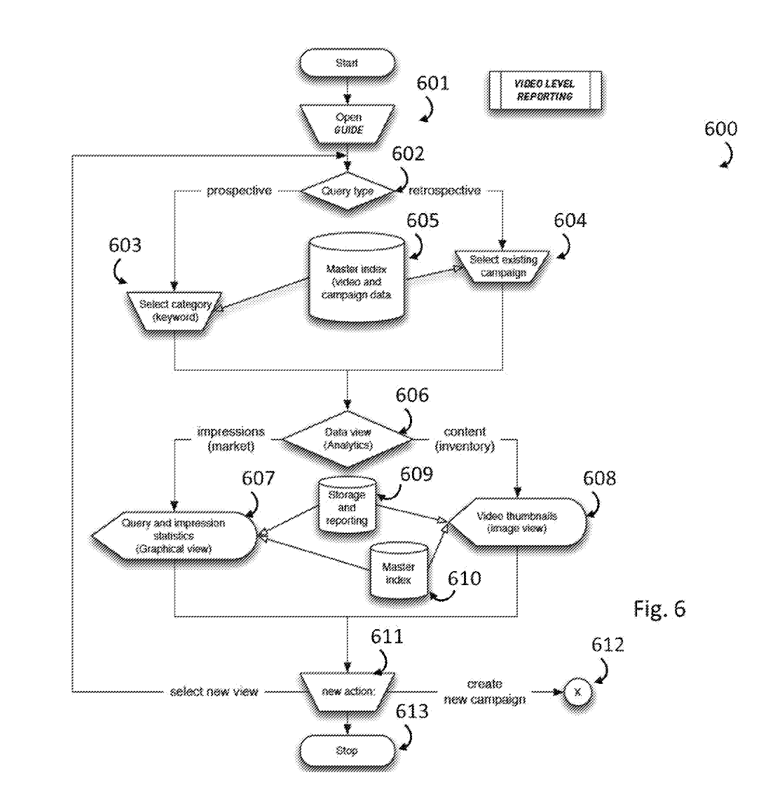

FIG. 6 is a flow diagram illustrating the steps for performing video-level reporting, according to aspects of the present disclosure. At step 601, an account agent or a representative of the advertiser opens an interface of the disclosed system. At step 602, the system receives a query. According to the query type the system selects an existing campaign 604, if the query is retrospective, e.g., for an existing campaign, or selects a category 603, if the query is prospective, e.g., for a new campaign. In either case, the master index module, 108, provides video and campaign data at step 605.

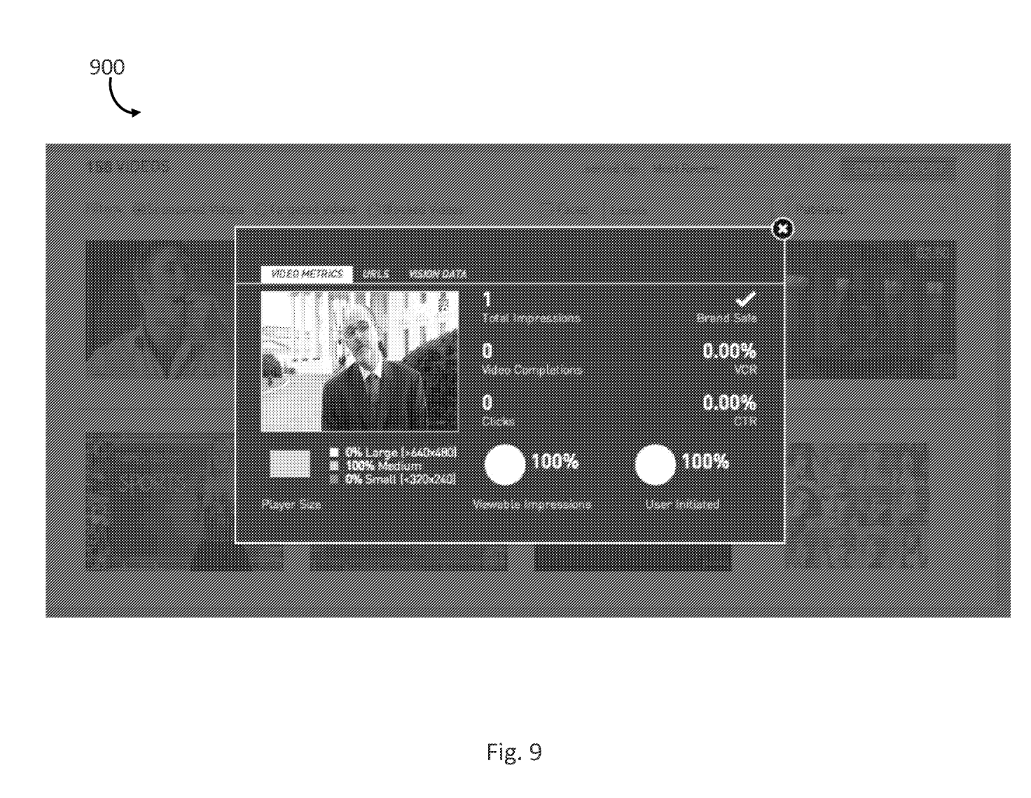

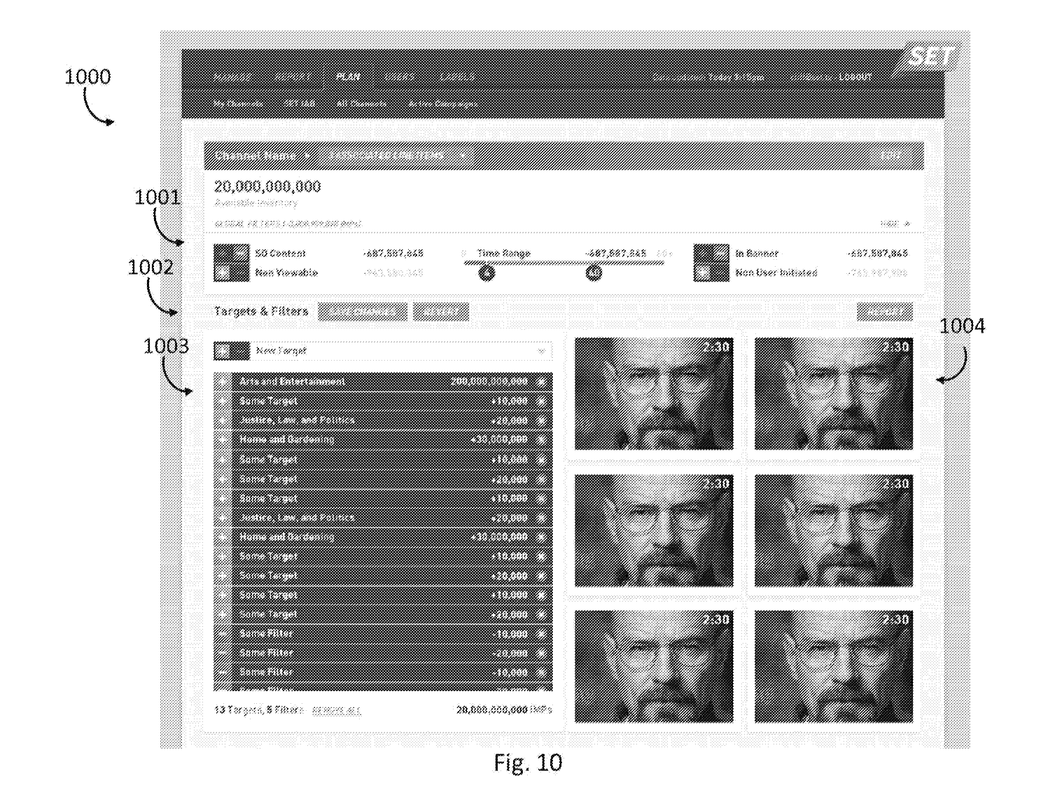

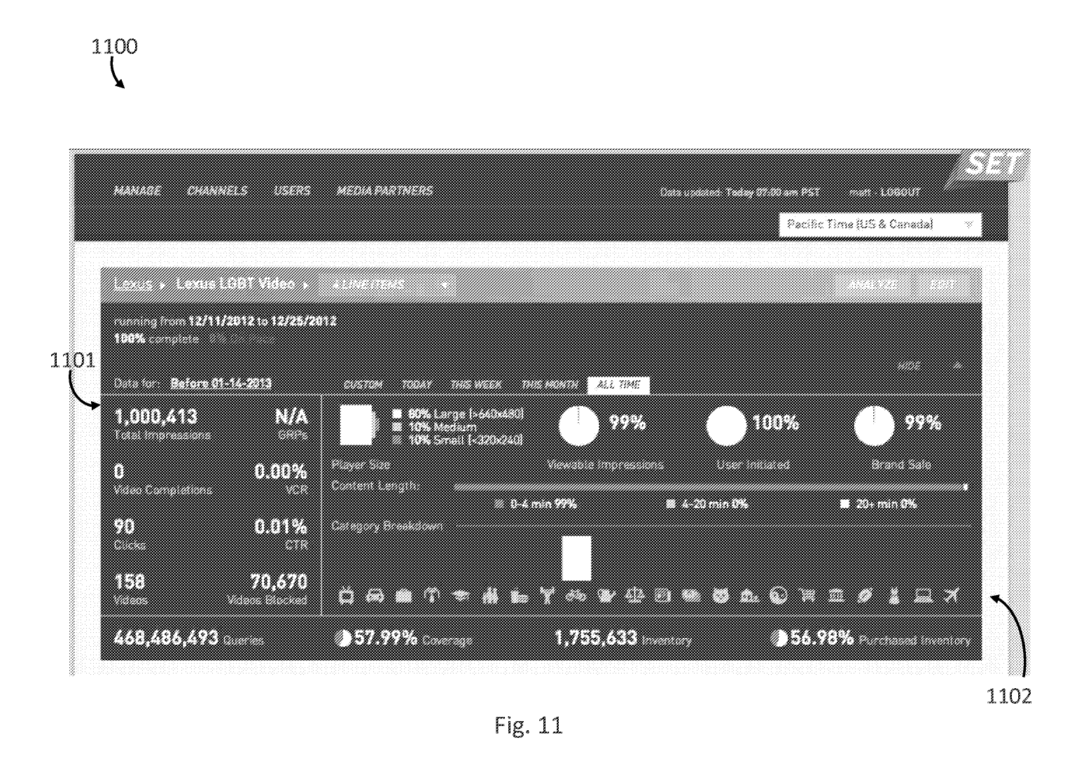

At step 606, the system checks for a data view type, in connection with the Analytics module 107. If the “impressions data” view is selected (step 607), the system provides query and impression statistics, for example, as discussed in connection with FIGS. 9 and 11. The system can provide different illustrations for the various statistics, for example, graphical view of the statistics. If alternatively the “video thumbnails” view is selected (step 608), the system provides video thumbnails, for example, images from the corresponding videos, as discussed in connection with FIG. 10. Both the query and impressions statistics view and video thumbnails view receive data from the storage system and reporting module 104 and the master index module 107.

At step 611, the system can either stop the reporting (step 613), create a new campaign (step 612), or select a new view, in which case the process initiates again by returning to step 602.

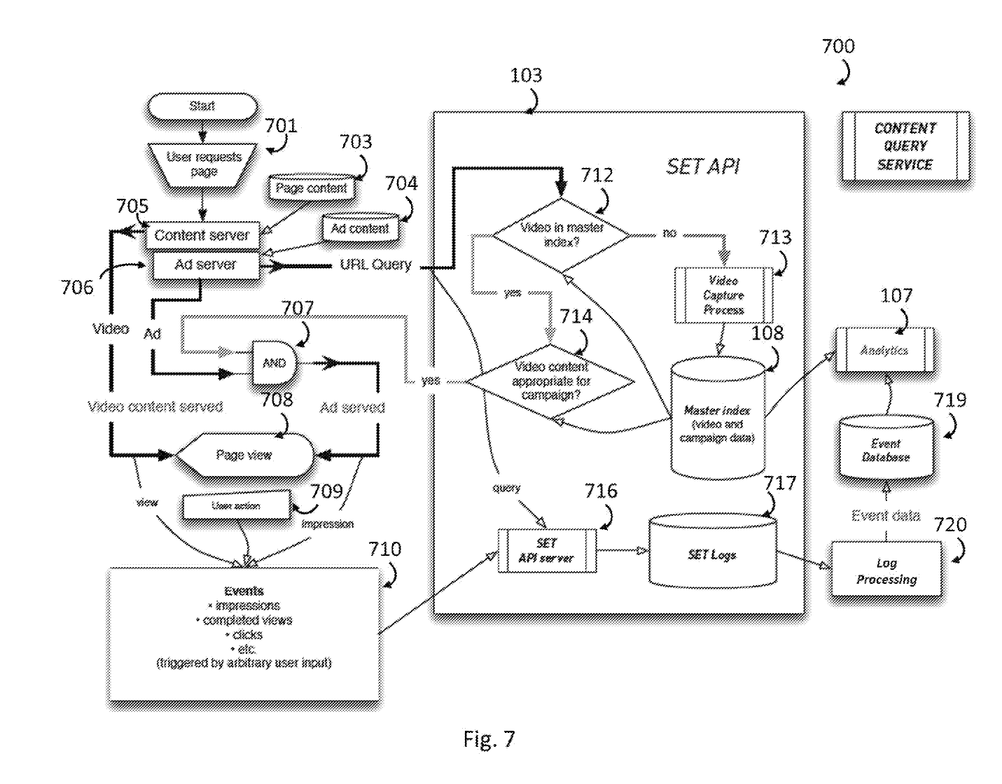

FIG. 7 is a flow diagram illustrating the steps for performing content query service, according to aspects of the present disclosure. At step 701 the user requests a webpage. The request is serviced by a content server (step 705) and an ad server (step 706). The content server can receive the content from a page content database (step 703) and the ad server can receive data from an ad content database (step 704).

The API module 103 receives a URL query and determines whether the video is included in the master index module 107. If the video is in the master index, then the system determines, at step 714, whether the video content is appropriate for a particular campaign. In such case, if, in addition, the particular ad is available, the ad is served and included in the page view at step 708. In step 710 the system logs different events, for example, completed video views, impressions, clicks, and other user actions or inputs.

In step 712, if the video requested by the user is not included in the master index, then a video capture process begins (step 713). After the video has been captured, the video is included in the master index 108 and the corresponding data, e.g., the data stored in the master index after the video has been classified by the video capture module, can be provided to the analytics module 107.

The API module 103 can also include an API server 716, which receives the different logged events and also the URL queries. The API module 103 can also include a Logs database (717) which provides log data to a log processing module (720), which in turn can provide event data to an event database (719).

FIG. 9 shows an interface 900 of a system according to aspects of the disclosure. Specifically, the interface 900 provides, for a particular video, the video completion rate, total impressions (total number of times the advertisement was served), the number of view completions (number of times the advertisement was viewed in its entirety), the number of clicks, the click through rate (the number of times a click is made on the advertisement divided by the total impressions) and verification data, for example, whether the video is “brand safe,” for example, whether it corresponds to a content category that has been selected or approved by the advertiser, viewable impressions, for example, the percentage of the total impressions that are “seen” by viewers, and player size. It should be understood that interface 900 is an exemplary interface. According to alternative embodiments, the interface can include less data, additional data, or any suitable combination of data. Additionally, the interface can present the data in any suitable arrangement and order.

FIG. 10 shows another interface 1000 of the system providing video-level analytics for a particular channel. Specifically, section 1001 provides information on the total impression opportunity, which is the amount that an advertiser can buy based on specific configurations. Section 1002 shows the possible filter selections for content filtered from ad campaigns, for example, particular time range. Section 1003 shows the targets with their labels and estimated impression counts. For example, targets can include, Arts and Entertainment and Home and Gardening. Finally, section 1004 shows the videos that a particular ad campaign could target based on specific configurations. It should be understood that interface 1000 is an exemplary interface. According to alternative embodiments, the interface can include less data, additional data, or any suitable combination of data. Additionally, the interface can present the data in any suitable arrangement and order.

FIG. 11 shows another interface 1100 of the system, providing video-level analytics for a particular campaign. Section 1101 shows GRP numbers, which are represented at every level of the campaign. The interface further shows the player size represented with shapes based on the campaign. The content of the video is broken down and represented as a line. Section 1102 shows the difference category breakdown. It should be understood that interface 1100 is an exemplary interface. According to alternative embodiments, the interface can include less data, additional data, or any suitable combination of data. Additionally, the interface can present the data in any suitable arrangement and order.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, systems and media for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

What is claimed is:

1. A computer-implemented video-level reporting system for determining the performance of an advertisement being served on a user device during an advertisement campaign defined by an advertiser, comprising:
an application programming interface (API) implemented on the computer configured to receive from an advertisement server a Uniform Resource Location (URL) of a video requested by a user and information provided by the advertiser;
a storage system for storing advertisement-related information; and
an analytics module implemented on the computer configured to receive the stored advertisement-related information from the storage system, identify at least one user activity comprising a user interaction with the advertisement being served on the user device and analyze a performance of the advertisement based on the identified user activity and the stored advertisement-related information.

2. The computer-implemented video-level reporting system of claim 1, wherein the API is configured to determine whether the requested video matches the advertisement campaign, and when the requested video matches the advertising campaign to allow the advertisement server to serve the advertisement to the user device.

3. The computer-implemented video-level reporting system of claim 2, further comprising:
a video capture module implemented on the computer configured to ingest content from the requested video and content from a webpage corresponding to the URL, to classify the requested video into at least one category, and generate an index corresponding to the requested video and advertisement campaign information; and
a master index module implemented on the computer configured to receive the index from the video capture module and store the index from the video capture module.

4. The computer-implemented video-level reporting system of claim 3, wherein the analytics module is further configured to receive from the master index module the index corresponding to the requested video and the advertisement campaign information and to compare the performance of the advertisement with a second performance of a different advertisement.

5. The computer-implemented video-level reporting system of claim 3, further comprising a detector training module implemented on the computer configured to train and test classification detectors.

6. The computer-implemented video-level reporting system of claim 1, wherein when the API cannot determine whether the requested video matches the advertisement campaign,
the storage system is configured to receive from the API and store the URL and the video requested by the user and
a video capture module implemented on the computer is configured to receive from the storage system the stored URL and the stored video requested by the user and to ingest content from the stored requested video and content from a webpage corresponding to the stored URL, to classify the requested video into at least one category.

7. The computer-implemented video-level reporting system of claim 1, wherein the information provided by the advertiser comprises at least one advertising target.

8. The computer-implemented video-level reporting system of claim 1, wherein the user activities comprise at least one of a start action, a complete action, a pause action, a mute action, a rewind action and a resume action.

9. A computer-implemented video-level reporting method for determining the performance of an advertisement being served on a user device during an advertisement campaign defined by an advertiser, comprising the steps of:
receiving by an application programming interface (API) implemented on the computer from an advertisement server a Uniform Resource Location (URL) of a video requested by a user and information provided by the advertiser;
storing advertisement-related information in a storage system;
receiving by an analytics module implemented on the computer the stored advertisement-related information from the storage system;
identifying by the analytics module implemented on the computer at least one user activity comprising a user interaction with the advertisement being served on the user device; and
analyzing by the analytics module implemented on the computer a performance of the advertisement based on the identified user activity and the stored advertisement-related information.

10. The computer-implemented video-level reporting method of claim 9, further comprising:
determining by the API whether the requested video matches the advertisement campaign; and
when the requested video matches the advertising campaign, allowing the advertisement server to serve the advertisement to the user device.

11. The computer-implemented video-level reporting method of claim 10, further comprising:
ingesting by a video capture module implemented on the computer content from the requested video and content from a webpage corresponding to the URL, to classify the requested video into at least one category;
generating by the video capture module implemented on the computer an index corresponding to the requested video and advertisement campaign information; and
receiving and storing by a master index module implemented on the computer the index from the video capture module.

12. The computer-implemented video-level reporting method of claim 11, further comprising:
receiving by the analytics module the index corresponding to the requested video and the advertisement campaign information from the master index module; and
comparing the performance of the advertisement with a second performance of a different advertisement.

13. The computer-implemented video-level reporting method of claim 11, further comprising training and testing classification detectors by a detector training module implemented on the computer.

14. The computer-implemented video-level reporting method of claim 9, wherein when the API cannot determine whether the requested video matches the advertisement campaign,
by the storage system, receiving from the API and storing the URL and the video requested by the user;
by a video capture module implemented on the computer, receiving from the storage system the stored URL and the stored video requested by the user; and
by a video capture module implemented on the computer, ingesting content from the stored requested video and content from a webpage corresponding to the stored URL, to classify the requested video into at least one category.

15. The computer-implemented video-level reporting method of claim 9, wherein the information provided by the advertiser comprises at least one advertising target.

16. The computer-implemented video-level reporting method of claim 9, wherein the user activities comprise at least one of a start action, a complete action, a pause action, a mute action, a rewind action and a resume action.

17. A non-transitory computer readable media for determining the performance of an advertisement being served on a user device during an advertisement campaign defined by an advertiser, the non-transitory computer readable media including instructions that when executed by a computer system cause the computer system to:
receive by an application programming interface (API) from an advertisement server a Uniform Resource Location (URL) of a video requested by a user and information provided by the advertiser;
store advertisement-related information in a storage system;
receive by an analytics module the stored advertisement-related information from the storage system;
identify by the analytics module at least one user activity comprising a user interaction with the advertisement being served on the user device; and
analyze by the analytics module a performance of the advertisement based on the identified user activity and the stored advertisement-related information.
